(19) United States
(12) Patent Application Publication
(10) Pub. No.: US 2026/0017983 A1
(43) Pub. Date: Jan. 15, 2026

(54) INFORMATION PROCESSING APPARATUS, INFORMATION PROCESSING METHOD, AND NON-TRANSITORY RECORDING MEDIUM

(71) Applicant: NEC Corporation, Minato-ku, Tokyo (JP)

(72) Inventor: Ryoma OAMI, Tokyo (JP)

(73) Assignee: NEC Corporation, Minato-ku, Tokyo (JP)

(21) Appl. No.: 18/845,944

(22) PCT Filed: Mar. 18, 2022
(86) PCT No.: PCT/JP2022/012736

§ 371 Date: Mar. 7, 2025

(51) Int. Cl. G06V 40/18; G06V 10/44; G06V 10/75; G06V 40/60

(52) U.S. Cl. CPC G06V 40/197; G06V 10/44; G06V 10/751; G06V 40/193; G06V 40/60

(57) ABSTRACT

An information processing apparatus 1 comprising: a determination portion 11 that determines, in a case where an iris authentication target person is wearing a patterned contact lens including a predetermined pattern area, from an eye image including an eye of the iris authentication target person, an inner boundary of the pattern area included in the eye image; and an iris authentication portion 12 that performs iris authentication for the iris authentication target person based on the inner boundary.

### TECHNICAL FIELD

This disclosure relates to an information processing apparatus, an information processing method, and a recording medium.

### BACKGROUND ART

There is described in Patent Document 1 a technique in which: a band limiting processing for limiting a frequency band is performed on an original image in which an eye is captured: positions of the iris outer edge and pupil outer edge are detected from the post-processing image: an iris area is cut out from the original image based on the positions of the iris outer edge and pupil outer edge detected: and a feature is extracted to generate an iris code, and thereby, a frequency of an occurrence of self-rejection caused by a performance of a camera for taking the image of the eye is reduced in a personal iris authentication. There is described in Patent Document 2 a technique in which: an image of an iris area extracted from an eyeball image for registration is set to a registered iris pattern image (a normalized image) with the polar-coordinates conversion: an image of the iris area extracted from an eyeball image for verification is set to a verification iris pattern image (a normalized image) with the polar-coordinates conversion: and the verification iris pattern image is verified with the registered iris pattern image by the BLPOC (the band limited phase-only correlation), and thereby, an accurate iris authentication can be performed, even if there is a slight error in extraction of an image from an eyeball image. There is described in Patent Document 3 a technique in which: an eye as a subject is photographed in an oblique direction with respect to a line of sight: an ellipse-shaped iris image is detected from the photographed image: and it is determined whether or not the subject is an eye of a living body depending on whether or not the iris image can be detected, and thereby, a living-body discrimination is effectively performed on a sphere-shaped counterfeit similar to an eye of a living body such as a false eye. There is described in Patent Document 4 a technique in which: a plurality of eye images of an iris authentication target person are photographed: each of the plurality of eye images captured is evaluated: and among the plurality of eye images, an eye image evaluated as best is subjected to the iris authentication processing, and thereby, each of the iris authentication target persons is subjected to iris authentication processing or registered processing by the eye image photographed under the best conditions. There is described in Patent Document 5 a technique in which: a determination target image including a side portion of an outer periphery of an iris is extracted from an image including an eye: and, based on the determination target image, it is determined whether or not a colored contact lens is worn. There is described in Patent Document 6 a technique in which: an eye image of a target person is obtained: the eye image and a reference image are compared to each other to specify a colored pattern of a colored contact lens worn by the target person: and the target person is specified using features in, within the iris area of the eye, an area other than a colored area of the colored pattern, and thereby, even when the colored contact lens is worn, a decrease in authentication accuracy of an iris authentication is suppressed.

### CITATION LIST

### Patent Document

Patent Document 1: JP 2004-280221 A
Patent Document 2: JP 2007-034876 A
Patent Document 3: JP 2007-041831 A
Patent Document 4: JP 2007-159610 A
Patent Document 5: WO 2019/044944 A1
Patent Document 6: WO 2020/065935 A1

### SUMMARY

### Technical Problem

The object of this disclosure is to provide an information processing apparatus, information processing method, and recording medium for improving techniques described in the Citation List.

### Solution to Problem

One aspect of the information processing apparatus is an information processing apparatus comprising: a determination unit that determines, in a case where an iris authentication target person is wearing a patterned contact lens including a predetermined pattern area, from an eye image including an eye of the iris authentication target person, an inner boundary of the pattern area included in the eye image: and an iris authentication unit that performs iris authentication for the iris authentication target person based on the inner boundary.

One aspect of the information processing method is an information processing method comprising: determining, in a case where an iris authentication target person is wearing a patterned contact lens including a predetermined pattern area, from an eye image including an eye of the iris authentication target person, an inner boundary of the pattern area included in the eye image: and performing iris authentication for the iris authentication target person based on the inner boundary.

One aspect of the recording medium is a recording medium on which a computer program that allows a computer to execute an information processing method is recorded, the information processing method comprising: determining, in a case where an iris authentication target person is wearing a patterned contact lens including a predetermined pattern area, from an eye image including an eye of the iris authentication target person, an inner boundary of the pattern area included in the eye image: and performing iris authentication for the iris authentication target person based on the inner boundary.

### BRIEF DESCRIPTION OF DRAWINGS

FIG. 1 is a block diagram illustrating a configuration of an information processing apparatus according to a first example embodiment.

FIG. 2 is a block diagram illustrating a configuration of the information processing apparatus according to a second example embodiment.

FIG. 3 is a flow chart showing a flow of an information processing operation to be performed by the information processing apparatus according to the second example embodiment.

FIG. 4 shows conceptual diagrams with respect to an eyeball of an iris-authentication target person wearing a patterned contact lens.

FIG. 5 includes flow charts showing a flow of the information processing operation to be performed by the information processing apparatus according to a third example embodiment.

FIG. 6 shows conceptual diagrams with respect to a determination operation of an inner boundary in the third example embodiment.

FIG. 7 is a block diagram illustrating a configuration of the information processing apparatus according to a fourth example embodiment.

FIG. 8 includes flow charts showing a flow of the information processing operation performed by the information processing apparatus according to the fourth example embodiment.

FIG. 9 shows conceptual diagrams with respect to the determination operation of the inner boundary in the fourth example embodiment.

FIG. 10 includes flow charts showing a flow of the information processing operation to be performed by the information processing apparatus according to a fifth example embodiment.

FIG. 11 shows conceptual diagrams with respect to the determination operation of the inner boundary in the fifth example embodiment.

FIG. 12 is a flow chart showing a flow of the determination operation of the inner boundary to be performed by the information processing apparatus according to the fifth example embodiment.

FIG. 13 includes flow charts showing a flow of the information processing operation to be performed by the information processing apparatus according to a sixth example embodiment.

FIG. 14 is a block diagram illustrating a configuration of the information processing apparatus according to a seventh example embodiment.

FIG. 15 is a flow chart showing a flow of the information processing operation to be performed by the information processing apparatus according to the seventh example embodiment.

FIG. 16 is a block diagram illustrating a configuration of the information processing apparatus according to an eighth example embodiment.

FIG. 17 is a flow chart showing a flow of the information processing operation to be performed by the information processing apparatus according to the eighth example embodiment.

### DESCRIPTION OF EXAMPLE EMBODIMENTS

There will be described below example embodiments referring to the drawings, with respect to an information processing apparatus, information processing method, and recording medium.

### 1: First Example Embodiment

A first example embodiment of an information processing apparatus, information processing method, and recording medium will be described. Hereinafter, there will be described the first embodiment of the information processing apparatus, information processing method, and recording medium, using an information processing apparatus 1 to which the first example embodiment of the information processing apparatus, information processing method, and recording medium is applied.

### 1-1: Configuration of Information Processing Apparatus 1

Referring to FIG. 1, a configuration of the information processing apparatus 1 according to the first example embodiment will be described. FIG. 1 is a block diagram illustrating the configuration of the information processing apparatus 1 according to the first example embodiment.

As shown in FIG. 1, the information processing apparatus 1 according to the first example embodiment comprises a determination portion 11 and an iris authentication portion 12. When an iris authentication target person wears a patterned contact lens including a predetermined pattern area, the determination portion 11 is configured to determine from an eye image including an eye of the iris authentication target person, the inner boundary of the pattern area included in the eye image. The predetermined pattern area included in the patterned contact lens may be a ring-shaped pattern area. The predetermined pattern area may be a U-shaped area, or may be an area where a star pattern is put at one point. The iris authentication portion 12 is configured to perform iris authentication of the iris authentication target person based on the inner boundary.

### 1-2: Technical Effectiveness of Information Processing Apparatus 1

The information processing apparatus 1 according to the first example embodiment can authenticate the iris authentication target person even when the iris authentication target person wears the patterned contact lens.

### 2: Second Example Embodiment

A second example embodiment of an information processing apparatus, information processing method, and recording medium will be described. Hereinafter, there will be described the second example embodiment of the information processing apparatus, information processing method, and recording medium, using an information processing apparatus 2 to which the second example embodiment of the information processing apparatus, information processing method, and recording medium is applied.

### 2-1: Configuration of Information Processing Apparatus 2

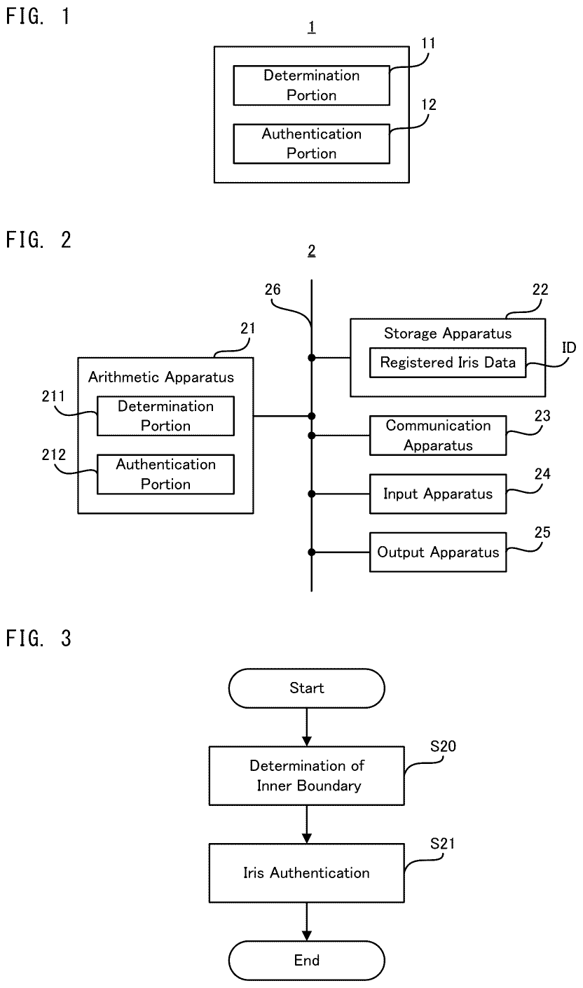

Referring to FIG. 2, a configuration of the information processing apparatus 2 according to the second example embodiment will be described. FIG. 2 is a block diagram illustrating the configuration of the information processing apparatus 2 according to the second example embodiment.

As shown in FIG. 2, the information processing apparatus 2 comprises an arithmetic apparatus 21 and a storage apparatus 22. Furthermore, the information processing apparatus 2 may comprise a communication apparatus 23, an input apparatus 24, and an output apparatus 25. However, the information processing apparatus 2 may not comprise at least one of the communication apparatus 23, the input apparatus 24, and the output apparatus 25. The arithmetic apparatus 21, the storage apparatus 22, the communication apparatus 23, the input apparatus 24, and the output apparatus 25 may be connected through the data bus 26.

The arithmetic apparatus 21 includes at least one of, for example, CPU (Central Processing Unit), GPU (Graphics Processing Unit), and FPGA (Field Programmable Gate Array). The arithmetic apparatus 21 reads a computer program. For example, the arithmetic apparatus 21 may read a computer program stored in the storage apparatus 22. For example, the arithmetic apparatus 21 may read a computer program stored in a computer-readable and non-transient recording medium, using a recording-medium read apparatus, not shown, provided by the information processing apparatus 2 (e.g., the input apparatus 24, which will be described later). The arithmetic apparatus 21 may acquire (i.e., download or read) a computer program from an apparatus, not shown, disposed outside the information processing apparatus 2 via the communication apparatus 23 (or another communication apparatus). The arithmetic apparatus 21 executes the computer program loaded. Consequently, in the arithmetic apparatus 21, logical function blocks for executing operations to be performed by the information processing apparatus 2 are realized. In other words, the arithmetic apparatus 21 can function as a controller for realizing the logical function blocks for executing operations (in other words, processing) to be performed by the information processing apparatus 2.

FIG. 2 shows an example of the logical functional blocks realized in the arithmetic apparatus 21 for executing an information processing operation. As shown in FIG. 2, in the arithmetic apparatus 21, a determination portion 211 that is a specific example of “a determination unit” described in supplementary notes to be described later and an iris authentication portion 212 that is a specific example of “an iris authentication unit” described in the supplementary notes to be described later are realized.

The storage apparatus 22 is capable of storing desired data. For example, the storage apparatus 22 may temporarily store computer programs executed by the arithmetic apparatus 21. The storage apparatus 22 may temporarily store data that is temporarily used by the arithmetic apparatus 21 when the arithmetic apparatus 21 is running a computer program. The storage apparatus 22 may store data that the information processing apparatus 2 stores for long periods. The storage apparatus 22 may include at least one of a RAM (Random Access Memory), ROM (Read Only Memory, hard disk apparatus, magneto-optical disk apparatus, and SSD (Solid State Drive). That is, the storage apparatus 22 may include a non-transient recording medium.

The storage apparatus 22 may store registered iris data ID. The registered iris data ID may be data including an eye image of an authentication target person, who is registered, an iris image extracted from the eye image, a feature calculated from the iris image, and the like. The registered iris data ID may be used for an iris authentication operation executed by the iris authentication portion 212. However, the storage apparatus 22 may not store the registered iris data ID.

The communication apparatus 23 can communicate with an apparatus external to the information processing apparatus 2 through a communication network (not shown). The communication apparatus 23 may acquire the eye image to be used for the iris authentication operation from an imaging apparatus through the communication network. The imaging apparatus may be an infrared camera for taking an infrared image. The imaging apparatus may be a visible camera for taking a visible image.

The input apparatus 24 is an apparatus that receives input of information to the information processing apparatus 2 from the outside of the information processing apparatus 2. For example, the input apparatus 24 may include an operation apparatus (for example, at least one of a keyboard, mouse, and touch panel) operable by an operator of the information processing apparatus 2. For example, the input apparatus 24 may include a read apparatus that can read information recorded as data in a recording medium which is externally attachable to the information processing apparatus 2.

The output apparatus 25 is an apparatus that outputs information to the outside of the information processing apparatus 2. For example, the output apparatus 25 may output the information as an image. In other words, the output apparatus 25 may include a display apparatus (so-called a display) that is capable of displaying an image showing information to be output. For example, the output apparatus 25 may output information as sound. That is, the output apparatus 25 may include an audio apparatus (so-called a speaker) capable of outputting audio. For example, the output apparatus 25 may output information on a paper. In other words, the output apparatus 25 may include a print apparatus (so-called a printer) that can print desired information on a paper.

### 2-2: Information Processing Operation Performed by Information Processing Apparatus 2

Referring to FIG. 3, a flow of the information processing operation performed by the information processing apparatus 2 according to the second example embodiment will be described. FIG. 3 is a flow chart showing the flow of the information processing operation performed by the information processing apparatus 2 according to the second example embodiment.

As shown in FIG. 3, when the iris authentication target person wears the patterned contact lens including the ring-shaped pattern area, the determination portion 211 determines, from the eye image including the eye of the iris authentication target person, the inner boundary of the pattern area included in the eye image (step S20). The ring-shaped pattern area included in the patterned contact lens may include a colored area. The ring-shaped pattern area may include an area in which a pattern is formed. The inner boundary of the pattern area may be a boundary between the pattern area and a transparent area of the inside of the patterned contact lens.

The iris authentication portion 212 performs the iris authentication for the iris authentication target person based on the inner boundary (step S21). For example, the iris authentication portion 212 may extract the pattern area included in the patterned contact lens based on the inner boundary, mask the pattern area in the eye image, and perform the iris authentication for the iris authentication target person. That is, the iris authentication portion 212 may perform the iris authentication using the iris image where the pattern area included in the patterned contact lens is not overlapping. The iris authentication portion 212 may verify the iris image where the pattern area included in the patterned contact lens is not overlapping, with the registered iris data ID for the iris authentication. The iris authentication portion 212 may perform the iris authentication by verifying the feature extracted from the iris image where the pattern area included in the patterned contact lens is not overlapping, with the feature included in the registered iris data ID. Masking processing may be performed after extracting the feature. In other words, the extraction of the feature to be used for the verification may be performed on the unmasked image, and after the extraction of the feature, the verification may be performed with masking the feature corresponding to the pattern area of the patterned contact lens. Alternatively, in a case that matching processing at the verification is performed for each part area unit, the matching processing may be performed with respect to the feature before masking, and the verification may be performed with masking the matching result corresponding to the pattern area of the patterned contact lens.

### 2-3: Technical Effectiveness of Information Processing Apparatus 2

The information processing apparatus 2 according to the second example embodiment can perform the iris authentication for the iris authentication target person even when the iris authentication target person wears the patterned contact lens. In particular, the information processing apparatus 2 can perform the iris authentication for the iris authentication target person with a higher accuracy, in comparison to an iris authentication apparatus of a comparative example, which performs the iris authentication without using the inner boundary of the pattern area included in the eye image. The reason why is that, the iris authentication apparatus of the comparative example performs the iris authentication for the iris authentication target person without masking the pattern area included in the patterned contact lens in the eye image. That is, the iris authentication apparatus of the comparative example uses not only the pattern of the iris of the authentication target person captured in the eye image but also the pattern area of the patterned contact lens captured in the eye image, to perform the iris authentication for the iris authentication target person. For this reason, the iris authentication apparatus of the comparative example may erroneously recognize the pattern formed on the pattern area of the patterned contact lens as the pattern of the iris of the iris authentication target person. Consequently, the iris authentication apparatus of the comparative example may erroneously determine that the iris authentication target person is not a person A in a situation where it should be determined that the iris authentication target person is the person A. Meanwhile, the information processing apparatus 2 according to the second example embodiment can perform the iris authentication for the iris authentication target person after masking the pattern area included in the patterned contact lens in the eye image on the basis of the inner boundary. That is, the information processing apparatus 2 can perform the iris authentication for the iris authentication target person based on the inner boundary with using the iris pattern of the authentication target person captured in the eye image, but without using the pattern area of the patterned contact lens captured in the eye image. Therefore, the information processing apparatus 2 can perform the iris authentication for the iris-authentication target person without mistaking the pattern formed in the pattern area of the patterned contact lens as the iris pattern of the iris authentication target person. Consequently, with respect to the authentication accuracy, the information processing apparatus 2 is higher than the iris authentication apparatus of the comparative example. For this reason, the information processing apparatus 2 can reduce the risk that the iris authentication becomes unavailable when the iris authentication target person is wearing the patterned contact lens, and can improve usability. In other words, the information processing apparatus 2 can solve the technical problem that the iris authentication becomes unavailable when the iris authentication target person is wearing the patterned contact lens.

The case where the iris authentication is applied is increasing in such scenes: payment scenes such as payment from one's own account and payment by a credit card: restriction of entry scenes to restricted areas, etc.: and scenes for making devices function, such as logging in to devices such as PCs, and unlocking vehicles such as cars and motorcycles. On the other hand, the case that the iris authentication target person wears the patterned contact lenses when going out is increasing. The patterned contact lenses are not easily put on and off, compared to sunglasses, masks, etc. There is increasing demand for the iris authentication available to the iris authentication target person keeping on with the patterned contact lenses. Therefore, the information processing apparatus 2 according to the second example embodiment can satisfy the above demand of the iris authentication.

### 3: The Third Example Embodiment

A third example embodiment of an information processing apparatus, information processing method, and recording medium will be described. Hereinafter, there will be described the third example embodiment of the information processing apparatus, information processing method, and recording medium, using an information processing apparatus 3 to which the third example embodiment of the information processing apparatus, information processing method, and recording medium is applied.

Similarly to the information processing apparatus 2 according to the second example embodiment, the information processing apparatus 3 according to the third example embodiment comprises the arithmetic apparatus 21 and the storage apparatus 22. Furthermore, the information processing apparatus 3, similarly to the information processing apparatus 2, may comprise the communication apparatus 23, the input apparatus 24, and the output apparatus 25. However, the information processing apparatus 3 may not comprise at least one of the communication apparatus 23, the input apparatus 24, and the output apparatus 25. The information processing apparatus 3 according to the third example embodiment, as compared with the information processing apparatus 2 according to the second example embodiment, the determination operation by the determination portion 211 differs. The other features of the information processing apparatus 3 may be the same as those of the information processing apparatus 2.

### 3-1: Information Processing Operation Performed by Information Processing Apparatus 3

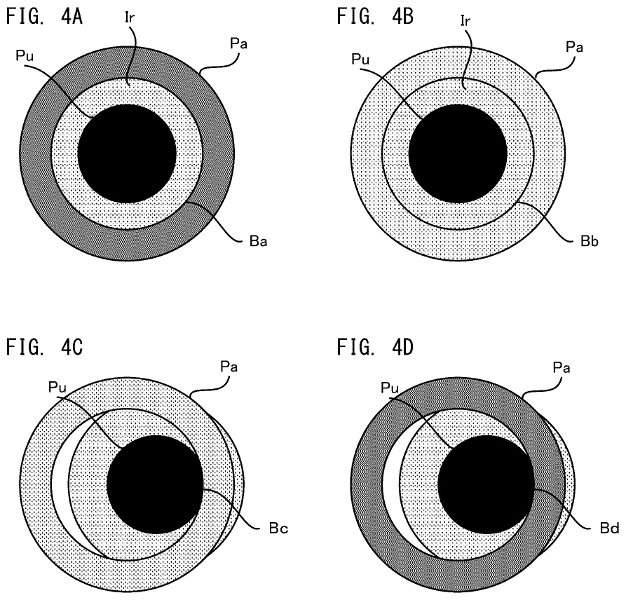

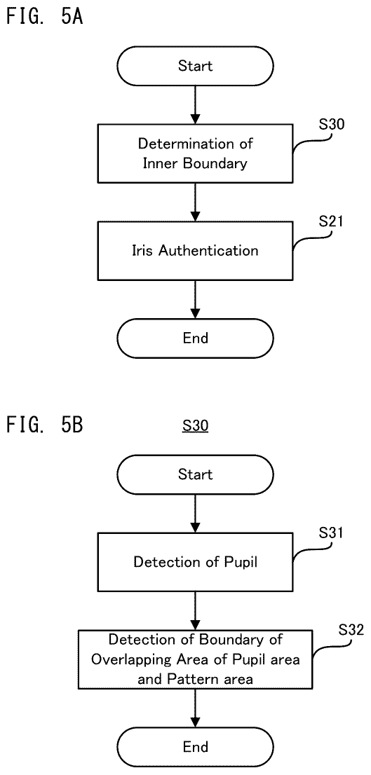

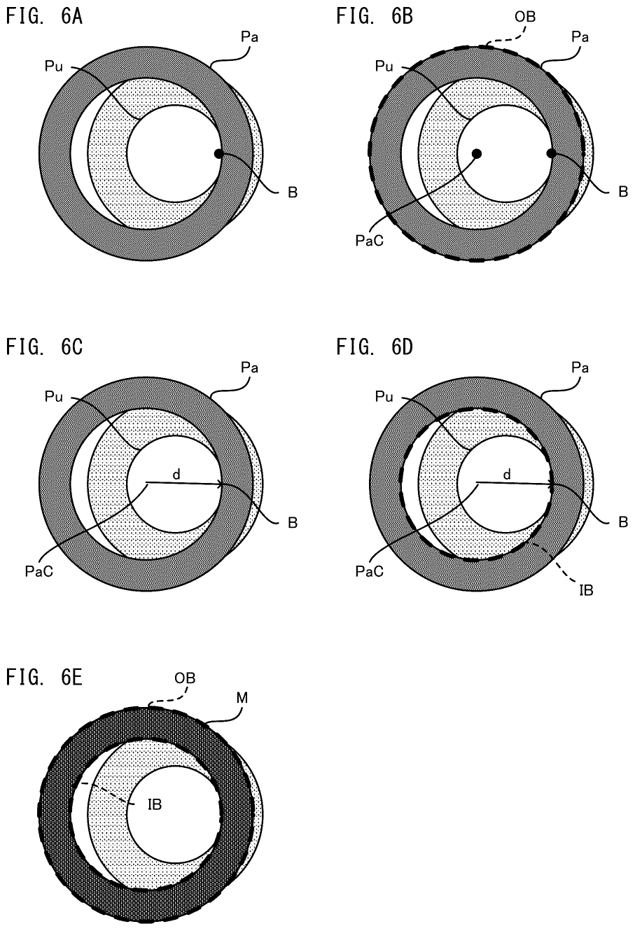

Referring to FIGS. 4 to 6, a flow of the information processing operation performed by the information processing apparatus 3 according to the third example embodiment will be described. FIG. 4 includes conceptual diagrams, each illustrating an eyeball of an iris authentication target person wearing a patterned contact lens. FIG. 5 includes flow charts showing a flow of the information processing operation performed by the information processing apparatus 3 according to the third example embodiment. FIG. 6 includes conceptual diagrams, each illustrating a determination example of the inner boundary of the pattern area Pa.

As shown in FIG. 4(a), the patterned contact lens is worn by the iris authentication target person so that the pattern area Pa overlaps the outer area of the iris area Ir. Therefore, when the iris authentication target person wears the patterned contact lens, the outer area of the iris area Ir where the pattern area Pa is overlapping, in the eye image including the eye of the iris authentication target person, cannot be used for the iris authentication.

As shown in FIG. 4(b), the iris area Ir and the pattern area Pa are often similar to each other in color, pattern, etc. When the iris area Ir and the pattern area Pa are similar, it becomes difficult to distinguish between them, and it is difficult to determine the inner boundary of the pattern area Pa based on the boundary Bb between the iris area Ir and the pattern area Pa.

On the other hand, as shown in FIG. 4(c), since cases where the pupil area Pu and the pattern area Pa are similar to each other in color, pattern are uncommon, it is relatively easy to distinguish between them. Therefore, it is relatively easy to determine the inner boundary of the pattern area Pa based on the boundary Bc between the pupil area Pu and the pattern area Pa. The boundary between the pupil area Pu and the pattern area Pa can be set to a reference for computing the inner radius of the pattern area Pa.

In addition, when FIG. 4(a) and FIG. 4(d) are compared, even when the iris area Ir and the pattern area Pa are not similar to each other, the boundary Bd between the pupil area Pu and pattern area Pa is more distinguishable than the boundary Ba between the iris area Ir and pattern area Pa. Therefore, when the pupil area Pu and the pattern area Pa is overlapping with each other, it is more preferable to determine the inner boundary of the pattern area Pa using the overlapping area. Therefore, in the third example embodiment, the area where the pupil area Pu and the pattern area Pa are overlapping with each other is used to determine the inner boundary.

As shown in FIG. 5(a), the determination portion 211 determines from an eye image including the eye of the iris authentication target person, the inner boundary of the pattern area Pa included in the eye image (step S30). The iris authentication portion 212 performs the iris authentication for the iris authentication target person based on the inner boundary of the pattern area Pa (step S21).

The operation on step S30 is shown in FIG. 5(b). As shown in FIG. 5(b), the determination portion 211 detects the pupil area Pu of the iris authentication target person included in the eye image (step S31). The determination portion 211 may detect the pupil area Pu included in the eye image of the iris authentication target person and the iris area Ir.

The determination portion 211 determines the inner boundary of the pattern area Pa using the area where the pupil area Pu included in the eye image of the iris authentication target person and the pattern area Pa in the eye image are overlapping with each other (step S32).

### 3-2: Determination Example of Inner Boundary of Pattern Area Pa

FIG. 6 includes conceptual diagrams, each illustrating a determination example of the inner boundary of the pattern area Pa. In FIG. 6, the pupil area Pu is shown in white for ease of understanding. When the pupil area Pu and the pattern area Pa are overlapping with each other, the determination portion 211 may calculate the inner radius of the pattern area Pa based on the distance from the central portion PaC of the patterned contact lens to the inner side of the overlapping area, and may determine the reference for computing inner boundary of the pattern area Pa based on the inner radius of the pattern area Pa.

As shown in FIG. 6(a), the determination portion 211 detects the inner portion B of the area where the pupil area Pu of the iris authentication target person included in the eye image and the pattern area Pa included in the eye image are overlapping with each other. The determination portion 211 may detect the inner portion B by, for example, extracting brightness change on the boundary between the pupil area Pu and the pattern area Pa.

As shown in FIG. 6(b), the determination portion 211 detects the central portion PaC of the patterned contact lens. The patterned contact lens is circular and the boundary between the outer boundary OB of the pattern area Pa and the white part of the eyeball is clear. Therefore, the determination portion 211 can determine the central portion PaC of the patterned contact lens from the outer boundary OB of the pattern area Pa. The outer boundary OB of the pattern area Pa may be detected by, for example, extracting brightness change on the boundary between the outer periphery of the pattern area Pa and the white part of the eyeball. The boundary between the outer boundary OB of the pattern area Pa of the patterned contact lens and the white part of the eyeball can be set to a reference for computing the outer radius of the pattern area Pa.

As shown in FIG. 6(c), the determination portion 211 determines the distance d from the central portion PaC of the patterned contact lens to the inner portion B. As shown in FIG. 6(d), the determination portion 211 may determine, as the inner boundary IB of the pattern area Pa, a circle whose center is the central portion PaC of the patterned contact lens and whose radius is the distance d. Since the inner boundary of the pattern area Pa is substantially circular, the determination portion 211 may determine the inner boundary IB of the pattern area Pa from the central portion PaC of the patterned contact lens and the distance d.

In step S21 in the third example embodiment, the iris authentication portion 212 may extract the iris feature by masking the pattern area Pa in the eye image. As shown in FIG. 6(e), the pattern area Pa may be masked by the pattern area M surrounded by the outer boundary OB and the inner boundary IB. The iris authentication portion 212 may verify the iris image where the pattern area included in the patterned contact lens is not overlapping, with the registered iris data ID, to perform the iris authentication. The iris authentication portion 212 may verify with the feature included in the registered iris data ID, the feature extracted from the iris image where the pattern area included in the patterned contact lens is not overlapping, to perform the iris authentication. Further, as described in the second example embodiment, the iris authentication portion 212 may perform the feature extraction using an image with no masking, and the masking processing may be performed after the feature extraction or after the matching processing.

### 3-3: Technical Effectiveness of Information Processing Apparatus 3

When the pupil area Pu of the iris authentication target person and the pattern area Pa are overlapping with each other, the information processing apparatus 3 according to the third example embodiment determines the inner boundary of the pattern area Pa using the overlapping area. Then, the information processing apparatus 3 can determine the inner boundary of the pattern area Pa more accurately. In addition, the information processing apparatus 3, by utilizing the feature of the shape of the patterned contact lens, can relatively easily determine the inner boundary IB of the pattern area Pa from the central portion PaC of the patterned contact lens and the distance d. The information processing apparatus 3 according to the third example embodiment can perform the iris authentication even when the iris area Ir and the pattern area Pa are similar to each other and the boundary between the iris area Ir and the pattern area Pa is unclear.

### 4: Fourth Example Embodiment

A fourth example embodiment of an information processing apparatus, information processing method, and recording medium will be described. Hereinafter, there will be described the fourth example embodiment of the information processing apparatus, information processing method, and recording medium, using an information processing apparatus 4 to which the fourth example embodiment of the information processing apparatus, information processing method, and recording medium is applied.

4-1: Configuration of information processing Apparatus 4

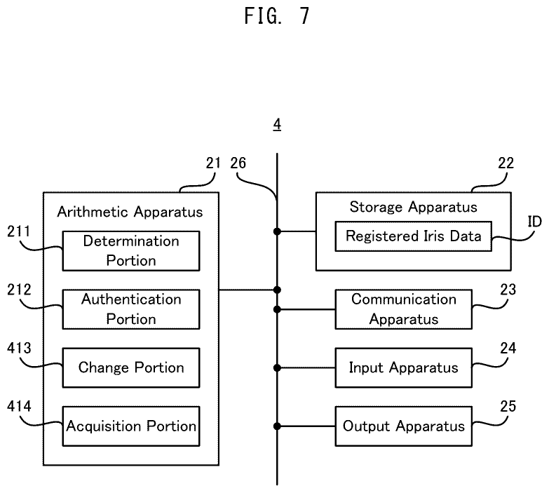

Referring to FIG. 7, a configuration of the information processing apparatus 4 according to the fourth example embodiment will be described. FIG. 7 is a block diagram illustrating the configuration of the information processing apparatus 4 according to the fourth example embodiment.

As shown in FIG. 7, the information processing apparatus 4 according to the fourth example embodiment comprises the arithmetic apparatus 21 and the storage apparatus 22, similarly to at least one of the information processing apparatus 2 according to the second example embodiment and the information processing apparatus 3 according to the third example embodiment. Furthermore, the information processing apparatus 4 may comprise the communication apparatus 23, the input apparatus 24, and the output apparatus 25, similarly to at least one of the information processing apparatus 2 and the information processing apparatus 3. However, the information processing apparatus 4 may not comprise at least one of the communication apparatus 23, the input apparatus 24, and the output apparatus 25. The information processing apparatus 4 according to the fourth example embodiment differs, in comparison with at least one of the information processing apparatus 2 according to the second example embodiment and the information processing apparatus 3 according to the third example embodiment, in that the arithmetic apparatus 21 includes the change portion 413 and the acquisition portion 414. The other features of the information processing apparatus 4 may be the same as those of at least one of the information processing apparatus 2 and the information processing apparatus 3. The change portion 413 and the acquisition portion 414 will be described later.

### 4-2: Information Processing Operation Performed by Information Processing Apparatus 4

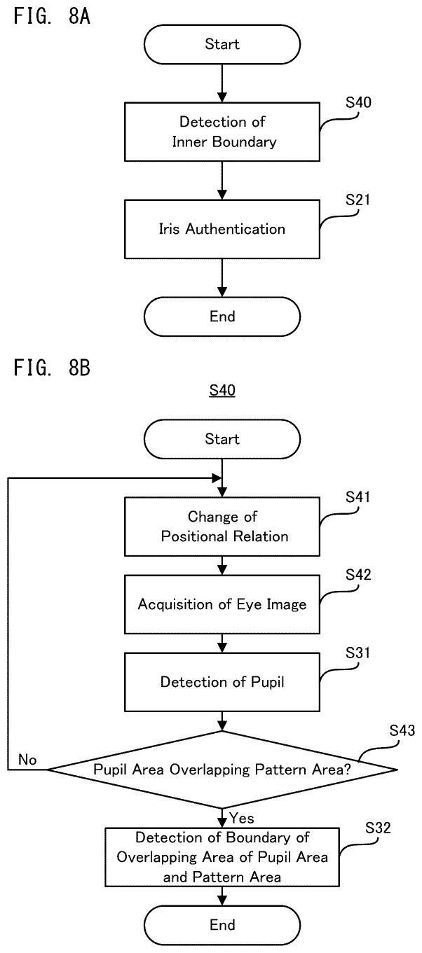

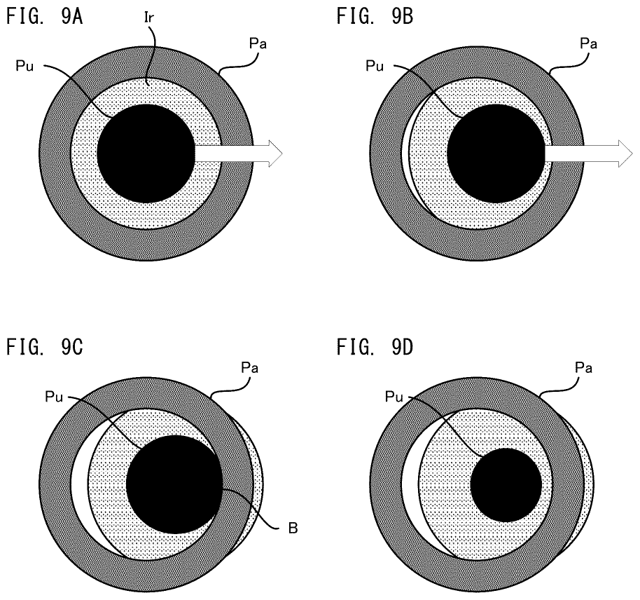

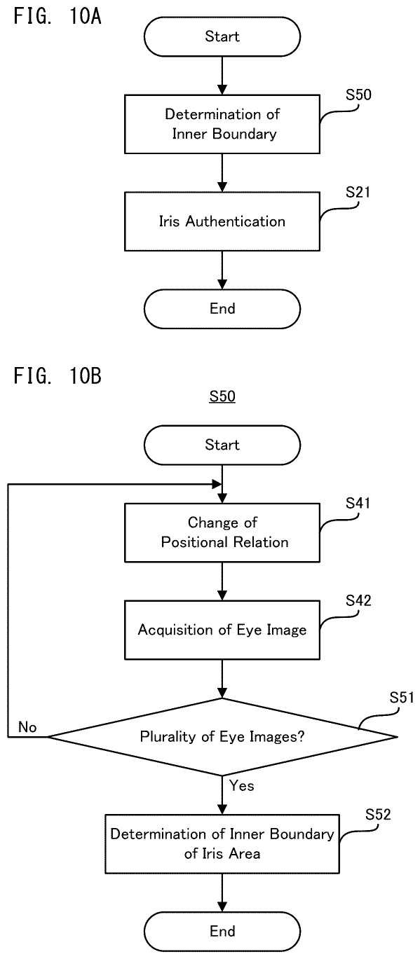

Referring to FIGS. 8 and 9, a flow of the information processing operation performed by the information processing apparatus 4 according to the fourth example embodiment will be described. FIG. 8 includes flowcharts showing the flow of the information processing operation performed by the information processing apparatus 4 according to the fourth example embodiment. FIG. 9 includes conceptual diagrams, each illustrating a case that the positional relation between a direction of a line of sight of the iris authentication target person and an imaging direction of the imaging apparatus for imaging the iris authentication target person is changed. The imaging apparatus may image the iris authentication target person to generate the eye image.

As shown in FIG. 8(a), the determination portion 211 determines from the eye image including the eye of the iris authentication target person, the inner boundary of the pattern area Pa included in the eye image (step S40). The iris authentication portion 212 performs the iris authentication for the iris authentication target person based on the inner boundary of the pattern area Pa (step S21).

The operation on step S40 is shown in FIG. 8(b). As shown in FIG. 8(b), the change portion 413 changes the positional relation between the direction of the line of sight of the iris authentication target person and the imaging direction of the imaging apparatus for imaging the iris authentication target person (step S41). The change portion 413 may change the positional relation by performing at least one of the first, second and third operations: the first operation is prompting the iris authentication target person to change the direction of the line of sight: the second operation is prompting the iris authentication target person to change the direction of his/her face while the direction of the line of sight is fixed: and the third operation is moving the imaging apparatus for imaging the iris authentication target person with respect to the iris authentication target person.

The change portion 413, when performing at least one of the first operation and the second operation, may control the output apparatus 25. In order to prompt the iris authentication target person to change the direction of the line of sight, the change portion 413 may make a speaker as the output apparatus 25 output sound such as “please look further right” or the like. Alternatively, in order to prompt the iris authentication target person to change the direction of the line of sight, the change portion 413 may make a display as the output apparatus 25 display an image, letters, or the like. The change portion 413 may move the image displayed on the display to make the line of sight of the iris authentication target person follow the image. With respect to the vertical direction of the eye, the pattern area Pa and iris area Ir may be covered by the lid. Therefore, the change portion 413 may prompt the iris authentication target person to change the direction of the line of sight of the iris authentication target person in the lateral direction and the oblique direction.

In addition, the change portion 413 may make the speaker as the output apparatus 25 output sound, in order to prompt the iris authentication target person to change the direction of the face while fixing the direction of the line of sight. Alternatively, in order to prompt the iris authentication target person to change the direction of the face while fixing the direction of the line of sight, the change portion 413 may make the display as the output apparatus 25 display an image, letters, or the like. Alternatively, when performing the third operation, the change portion 413 may control through the communication apparatus 23, the imaging apparatus to be moved with respect to the iris authentication target person.

The change portion 413 may change the position of the pupil area Pu of the iris authentication target person included in the eye image from the positions illustrated in FIGS. 9(a) and 9(b) to the position illustrated in FIG. 9(c).

The change portion 413 may perform output-control differently depending on the degree of changing the line of sight of the iris authentication target person. For example, the change portion 413, when asking for looking right further than a predetermination, may perform the output-control so as to display a longer right arrow as illustrated in FIG. 9(a). Further, the change portion 413, when asking for looking right a little further than a predetermination, may perform the output-control so as to display a short arrow as illustrated in FIG. 9(b).

The acquisition portion 414 acquires the eye image generated by the imaging apparatus (step S42). The determination portion 211 detects the pupil area Pu included in the eye image of the iris authentication target person (step S31). The determination portion 211 determines whether the pupil area Pu of the iris authentication target person included in the eye image is overlapping with the pattern area Pa included in the eye image (step S43).

If the pupil area Pu of the iris authentication target person included in the eye image is not overlapping with the pattern area Pa included in the eye image (step S43: No), the operation proceeds to step S41. For example, in a case that, though the change portion 413 changes the positional relation between the direction of the line of sight of the iris authentication target person and the imaging direction of the imaging apparatus for imaging the iris authentication target person, the pupil area Pu of the iris authentication target person included in the eye image is not overlapping with the pattern area Pa included in the eye image as shown in FIG. 9(b), the change portion 413 may further change the positional relation.

The operation may proceed to step S41 so that the change portion 413 further changes the positional relation, in a case that the pupil area Pu of the iris authentication target person included in the eye image and the pattern area Pa included in the eye image are not overlapping with each other, and also that the pupil area Pu included in the eye image of the iris authentication target person is equal to or larger than a predetermined size in comparison with the size of the iris. For example, the pupil area Pu becomes smaller in bright conditions. When the pupil area Pu is small, it is difficult that the pupil area Pu of the iris authentication target person included in the eye image and the pattern area Pa included in the eye image overlap with each other, even when the positional relation between the direction of the line of sight of the iris authentication target person and the imaging direction of the imaging apparatus for imaging the iris authentication target person is changed, as shown in FIG. 9(d). Therefore, when the pupil area Pu included in the eye image of the iris authentication target person is equal to or larger than a predetermined size in comparison with the size of the iris, the operation proceeds to step S41, and the change portion 413 may further change the positional relation.

When the pupil area Pu of the iris authentication target person included in the eye image and the pattern area Pa included in the eye image are overlapping with each other (step S43: Yes), the determination portion 211 determines the inner boundary of the pattern area Pa, using the overlapping area where the pupil area Pu of the iris authentication target person included in the eye image and the pattern area Pa included in the eye image are overlapping with each other (step S32). The iris authentication portion 212 extracts the iris feature by masking the pattern area Pa in the eye image, and performs the verification. Note that, as described in the second example embodiment, the masking processing may be performed after the feature extraction or after the matching processing.

In step S21 in the fourth example embodiment, the iris authentication portion 212 may use the eye image which has been captured after change of the positional relation between the direction of the line of sight of the iris authentication target person and the imaging direction of the imaging apparatus for imaging the iris authentication target person, or may use an image in which the positional relation has been adjusted. The iris authentication portion 212 may verify with the registered iris data ID, the iris area where the pattern area included in the patterned contact lens is not overlapping, to perform the iris authentication. The iris authentication portion 212 may verify with the feature included in the registered iris data ID, the feature extracted from the iris image where the pattern area included in the patterned contact lens is not overlapping, to perform the iris authentication.

### 4-3: Technical Effectiveness of Information Processing Apparatus 4

The information processing apparatus 4 according to the fourth example embodiment can promote the overlap between the pupil area Pu and the pattern area Pa by changing the positional relation between the direction of the line of sight of the iris authentication target person and the imaging direction of the imaging apparatus for imaging the iris authentication target person. In addition, the information processing apparatus 4 changes the positional relation when the pupil area Pu included in the eye image of the iris authentication target person is equal to or larger than a predetermined size in comparison with the size of the iris. Thereby, it is possible to suppress unnecessary operation when it is difficult for the pupil area Pu of the iris authentication target person included in the eye image to overlap with the pattern area Pa included in the eye image. Further, the information processing apparatus 4, by performing at least one of the first operation, the second operation, and the third operation, can change the positional relation by the operation suitable for the situation.

### 5: The Fifth Example Embodiment

A fifth example embodiment of an information processing apparatus, information processing method, and recording medium will be described. Hereinafter, there will be described the fifth example embodiment of the information processing apparatus, information processing method, and recording medium, using an information processing apparatus 5 to which the fifth example embodiment of the information processing apparatus, information processing method, and recording medium is applied.

Similarly to the information processing apparatus 4 according to the fourth example embodiment, the information processing apparatus 5 according to the fifth example embodiment comprises the arithmetic apparatus 21 and the storage apparatus 22. Furthermore, the information processing apparatus 5, similarly to the information processing apparatus 4, may comprise the communication apparatus 23, the input apparatus 24, and the output apparatus 25. However, the information processing apparatus 5 may not comprise at least one of the communication apparatus 23, the input apparatus 24, and the output apparatus 25. The information processing apparatus 5 according to the fifth example embodiment, as compared with the information processing apparatus 4 according to the fourth example embodiment, the determination operation by the determination portion 211 differs. The other features of the information processing apparatus 5 may be the same as those of the information processing apparatus 4.

### 5-1: Information Processing Operation Performed by Information Processing Apparatus 5

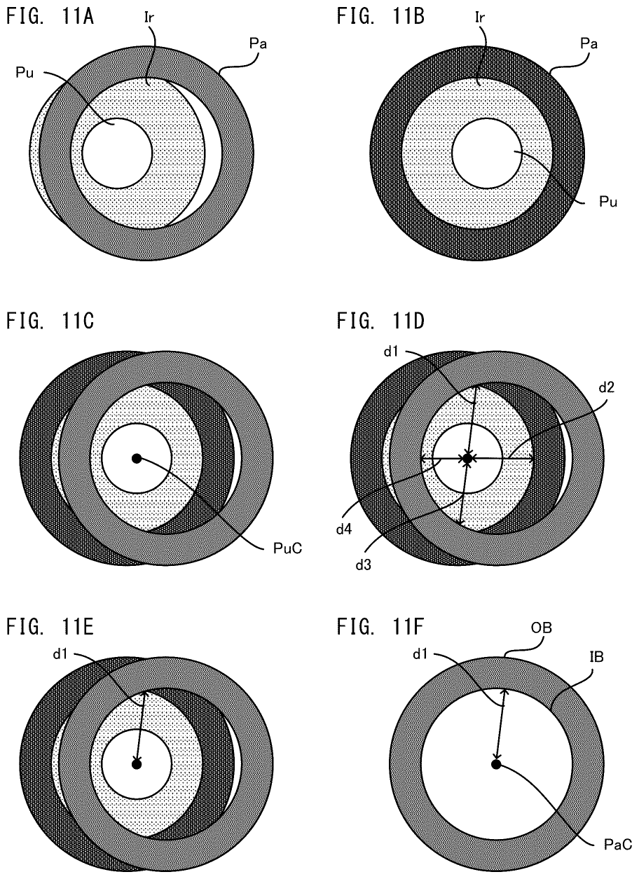

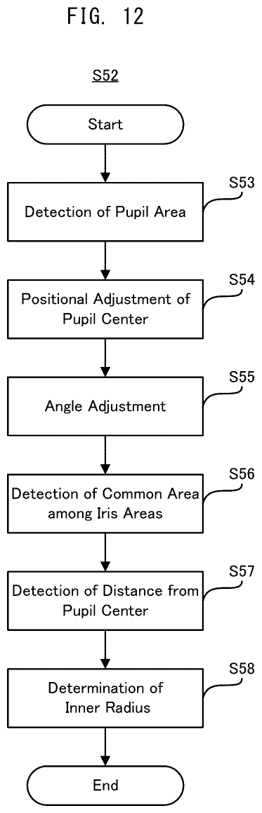

Referring to FIGS. 10 to 12, a flow of the information processing operation performed by the information processing apparatus 5 according to the fifth example embodiment will be described. FIG. 10 includes flow charts showing the flow of the information processing operation performed by the information processing apparatus 5 according to the fifth example embodiment. FIG. 11 includes conceptual diagrams, each illustrating an example of determining the inner boundary of the pattern area Pa. FIG. 12 is a flow chart showing a flow of the determination operation of the inner boundary of the pattern area Pa, that is performed by the information processing apparatus 5 according to the fifth example embodiment.

As shown in FIG. 10(a), the determination portion 211 determines the inner boundary of the pattern area Pa included in the eye image from the eye image including the eye of the iris authentication target person (step S50). The iris authentication portion 212 performs the iris authentication for the iris authentication target person based on the inner boundary of the pattern area Pa (step S21).

The operation on step S50 is shown in FIG. 10(b). As shown in FIG. 10(b), the change portion 413 changes the positional relation between the direction of the line of sight of the iris authentication target person and the imaging direction of the imaging apparatus for imaging the iris authentication target person (step S41).

The acquisition portion 414 acquires the eye image generated by the imaging apparatus (step S42). The determination portion 211 determines whether the acquisition portion 414 has acquired a plurality of eye images at least including a first eye image where the line of sight of the iris authentication target person is directed in a first direction, and a second eye image where the line of sight of the iris authentication target person is directed in a second direction differing from the first direction (step S51). The plurality of eye images may include at least one of: a plurality of eye images captured by making the iris authentication target person change the direction of the line of sight: a plurality of eye images captured by making the iris authentication target person change the direction of the face with fixing the direction of the line of sight of the iris authentication target person: a plurality of eye images captured by making the imaging apparatus for imaging the eye image move: and a plurality of eye images captured by a plurality of imaging apparatuses.

If the iris acquisition portion 414 has not yet acquired the plurality of eye images at least including the first eye image where the line of sight of the iris authentication target person is directed in the first direction and the second eye image where the line of sight of the iris authentication target person is directed in the second direction different from the first direction (step S51: No), the operation proceeds to step S41.

If the acquisition portion 414 has acquired the plurality of eye images at least including the first eye image where the line of sight of the iris authentication target person is directed in the first direction and the second eye image where the line of sight of the iris authentication target person is directed in the second direction different from the first direction (step S51: Yes), the determination portion 211 performs the determination operation of the inner boundary of the pattern area Pa in the fifth example embodiment (step S52).

### 5-2: Determination Operation for Inner Boundary of Pattern Area Pa

FIG. 11 includes conceptual diagrams, each illustrating a determination example of the inner boundary of the pattern area Pa. In FIGS. 11 each, the pupil area Pu is shown white for high visibility. FIG. 11(a) exemplarily illustrates the first eye image where the line of sight of the iris authentication target person is directed in the first direction. FIG. 11(b) exemplarily illustrates the second eye image where the line of sight of the iris authentication target person is directed in the second direction different from the first direction. Although FIGS. 11(a) and (b) show the eye images of the same iris authentication target person, the pattern area Pa of the patterned contact lens is represented with a different pattern from each other, for high visibility.

The iris area Ir is planar within the eyeball. Therefore, it is easy to perform image matching even among the iris areas Ir which have been captured from different orientations by rotating the eyeball. The verification of two eye images may be referred to as the image matching. On the other hand, the patterned contact lens is spherical in shape because it is worn on the eyeball. For this reason, the appearance of the pattern area Pa is different when viewed from a different direction other than the front direction. For this reason, it is difficult to perform the image matching between the pattern areas Pa, each being imaged from a different orientation by rotating the eyeball, in comparison to a planar iris. In addition, since the iris is visible in the area just outside of the pupil, an area where the image matching of the eye image including the periphery of the pupil was successful can be determined to be the iris area Ir, and at that time, an area where the above image matching was not successful can be determined to be the pattern area Pa.

In the fifth example embodiment, using the properties described above, the inner boundary of the pattern area Pa is determined using the plurality of eye images at least including the first eye image where the line of sight of the iris authentication target person is directed in the first direction and the second eye image where the line of sight of the iris authentication target person line is directed in the second direction different from the first direction. In addition, in the image matching, the iris feature may be extracted from each eye image in advance, and the matching may be performed between the features.

It is difficult to determine the boundary between the iris area Ir and the pattern area Pa using only one eye image. However, using a plurality of eye images, it is possible to distinguish the iris area Ir from the pattern area Pa and determine the inner boundary of the pattern area Pa.

As shown in FIG. 12, the determination portion 211 detects the pupil area Pu from the plurality of eye images (step S53).

The determination portion 211 performs positional adjustment of the center PuC of the pupil among the plurality of eye images (step S54). FIG. 11(c) is a conceptual diagram of the positional adjustment of the center PuC between the pupil of the first eye image and the pupil of the second eye image. If the sizes of iris and pupil differ between the eye images, the positional adjustment may be performed after deformation so that the sizes coincide among the eye images.

The determination portion 211 uses the pattern of the iris area Ir of the iris authentication target person close to the pupil area Pu of the iris authentication target person included in each of the plurality of eye images, to adjust the rotational angle around the pupil as the center PuC among the plurality of eye images (step S55). The plurality of eye images are the ones of the same iris authentication target person. Since an area close to at least the pupil area Pu is the iris area Ir, the image matching among the areas close to the pupil areas Pu is successful. Then, the determination portion 211 performs, at the beginning of the image matching between the first eye image and the second eye image, the image matching for the areas each being close to the pupil area Pu of the iris authentication target person included in the first eye image and the second eye image each, with using the pattern of the iris area Ir of the iris authentication target person, and then, adjusts the rotational angle around the pupil as the center PuC between the two eye images.

On the other hand, when the image matching among the areas close to the pupil area Pu is not successful in spite that the eye images are imaged by the same iris authentication target person, the determination portion 211 may determine that the iris authentication target person is unsuitable for the iris authentication. For example, if the iris authentication target person is wearing the patterned contact lens that overlaps with all area of the iris area Ir, the image matching among the areas close to the pupil area Pu is not successful.

The determination portion 211 may specify the rotational angle whose matching degree is high, by verifying the first eye image with the second eye image while rotating one of the first and second eye images with respect to the other one of the first and second eye images. For example, the determination portion 211 may, while rotating by each predetermined rotational angle, one of the first eye image and the second eye image around a position corresponding to the central portion PuC of the pupil area Pu as a center and in a predetermined rotational direction, calculate the matching degree for each rotational angle. The determination portion 211 may, by rotating one of the first eye image and the second eye image by each predetermined degree in a predetermined rotational direction, perform the positional adjustment with respect to the rotational direction. Any technique may be applied as a technique of the image matching. For example, with respect to the corresponding areas in the first eye image and the second eye image, the sum of differences between pixels: the number of differences between pixels is equal to or less than a threshold: or the correlation coefficient between the images may be calculated. Alternatively, by extracting the iris feature for verification from each of the first eye image and the second eye image, and performing the verification between the features, the size of area where the verification degree is equal to or larger than a predetermined threshold may be calculated. The determination portion 211 not only rotates one of the first eye image and the second eye image with respect to the other one of the first eye image and the second eye image, but also may enlarge or shrink one of the first eye image and the second eye image with respect to the other one of the first eye image and the second eye image.

The determination portion 211 performs the image matching between the first eye image and the second eye image, and detects a common area common to the first eye image and the second eye image (step S56). In FIG. 11(c), the determination portion 211 may detect as the common area, the iris area Ir which is not hidden by the pattern area Pa included in the first eye image and also not hidden by the pattern area Pa included in the second eye image.

The determination portion 211 may detect the common area that is common to the first eye image and second eye image in sequence toward the outer side of the area close to the pupil area Pu of the iris authentication target person. This is because when there is a position where the common area cannot be detected, in many cases, the outer side of the position is not detected as the common area.

The determination portion 211 may detect the common area including areas with respect to some directions. For example, the determination portion 211 may detect the common area including: an area lying rightward from the pupil area Pu (also referred to as the “area of 0°”); an area lying upward from the pupil area Pu (also referred to as the “area of 90°”): an area lying leftward from the pupil area Pu (also referred to as the “area of 180°”): and an area lying downward from the pupil area Pu (also referred to as the “area of 270°”). The determination portion 211 does not have to detect the common area including the areas in all directions. The determination portion 211 may detect the common area including an area suitable for determining the inner boundary.

The determination portion 211 calculates a distance from the center of the pupil area Pu to the outer boundary of the common area (step S57). FIG. 11(d) shows an example case that the common area including the areas with respect to four directions is detected. In the case illustrated in FIG. 11(d), the determination portion 211 may calculate the distance dl up to the outer boundary of the common area corresponding to the area in the first direction, the distance d2 up to the outer boundary of the common area corresponding to the area in the second direction, the distance d3 up to the outer boundary of the common area corresponding to the area in the third direction, and the distance d4 up to the outer boundary of the common area corresponding to the area in the fourth direction.

The determination portion 211, based on the longest length within the distances, calculates the inner radius of the pattern area (step S58). FIG. 11(e) illustrates the longest distance dl within the distances from the center of the pupil area Pu to the outer boundary of the common area illustrated in FIG. 11(d).

The determination portion 211 determines the inner boundary of the pattern area Pa based on the inner radius calculated. The determination portion 211 may determine as the inner boundary of the pattern area Pa, a circle having the inner radius and centered at the center PaC of the patterned contact lens. In the fifth example embodiment, in the example cases illustrated in FIG. 11, the inner radius of the patterned contact lenses may be determined to be the longest distance dl. FIG. 11(f) illustrates the center PaC of the single patterned contact lens and an area having the distance d1 from the center PaC, that is, the inner boundary of the pattern area Pa.

In the iris authentication, it is preferable to use a large iris area Ir. In other words, it is preferable to accurately determine the inner boundary of the pattern area Pa and use the largest iris area Ir that does not include the pattern area Pa for the iris authentication. When the determination portion 211 calculates the distance from the center of the pupil area Pu to the outer boundary of the common area with respect to all directions, it could be expected that the accuracy of the determination of the inner boundary of the pattern area Pa increases.

On the other hand, when the determination portion 211 calculates the distances from the center of the pupil area Pu to the outer boundary of the common area with respect to areas in some directions, it is possible to suppress the processing cost. The direction which elongates the distance from the center of the pupil area Pu to the outer boundary of the common area is related to the direction of the eye included in the eye image. Therefore, the determination portion 211 may estimate in which direction the line of sight is directed, and in accordance with the result, determine which angle where the distance is to be measured. In order to elongate the distance from the center of the pupil area Pu to the outer boundary of the common area in a particular direction, the change portion 413 may change the positional relation between the direction of the line of sight of the iris authentication target person and the imaging direction of the imaging apparatus for imaging the iris authentication target person. For example, the change portion 413 may change the positional relation between the direction of the line of sight of the iris authentication target person and the imaging direction of the imaging apparatus for imaging the iris authentication target person, so that the distance from the center of the pupil area Pu to the outer boundary of the common area elongates with respect to the area of 0° or the area of 180°. For example, with respect to the area of 90° and/or the area of 270°, it may happen that both of the iris area Ir and the pattern area Pa are partially hidden by the lid. Therefore, the change portion 413 may operate so that the area of 0° and the area of 180° may be used as an area to for calculation of the distance.

Above, the determination operation of the inner boundary on step S52 shown in FIG. has been described.

In step S21 in the fifth example embodiment, the iris authentication portion 212 may extract the iris feature from the iris area Ir on the inner side of the inner boundary of the pattern area Pa having the distance dl from the center PaC of the patterned contact lens in the eye image. As shown in FIG. 11(f), the pattern area Pa may be masked with the area surrounded by the outer boundary OB and inner boundary IB of the pattern area Pa. The iris authentication portion 212 may verify with the registered iris data ID, the iris image where the pattern area included in the patterned contact lens is not overlapping, to perform the iris authentication. The iris authentication portion 212 may verify with the feature included in the registered iris data ID, the feature extracted from the iris image where the pattern area included in the patterned contact lens is not overlapping, to perform the iris authentication.

The iris authentication portion 212 may perform the iris authentication based on the inner boundary, using the eye image captured after the change of the positional relation between the direction of the line of sight of the iris authentication target person and the imaging direction of the imaging apparatus for imaging the iris authentication target person. The iris authentication portion 212 may perform the iris authentication based on the inner boundary, using an image where the positional relation between the direction of the line of sight of the iris authentication target person and the imaging direction of the imaging apparatus for imaging the iris authentication target person has been adjusted.

The iris authentication portion 212 may use a plurality of eye images to perform the iris authentication based on the inner boundary. the iris authentication portion 212 may extract the iris area Ir on the inner side of the inner boundary of the pattern area Pa for each of the plurality of eye images, synthesize the images of a plurality of extracted iris areas Ir to be used for the iris authentication. As described above, in the iris authentication, it is preferable to use a large iris area Ir. In the eye image obtained by shifting the line of sight, the iris area Ir is sometimes reduced. Therefore, the images of the plurality of iris areas Ir may be synthesized and used for the iris authentication. Each of the eye images obtained by shifting the line of sight includes a different iris area Ir from each other. For this reason, when the images of the plurality of iris areas Ir are synthesized, the iris authentication portion 212 can perform the iris authentication using a larger iris area Ir. Note that the synthetic processing may be performed after extracting the feature. In other words, the iris feature may be extracted from each of the plurality of eye images and the extracted features may be synthesized.

The iris area Ir is captured in a direction from not the front in the eye image which is captured after the change of the positional relation between the direction of the line of sight of the iris authentication target person and the imaging direction of the imaging apparatus for imaging the iris authentication target person. Then, when the image of the iris area Ir captured in the direction not from the front is used for any one of: the determination of the inner boundary: the synthesization of images: the synthesization of features: and the iris authentication, the image may be corrected to be equivalent to the image of the iris area Ir captured from the front. In other words, an image of the iris area Ir having an ellipse shape may be corrected to an image of the iris area Ir having a precise circle shape. For example, by the affine transformation, the image of the iris area Ir having an ellipse shape may be transformed to the image of the iris area Ir having a precise circle shape.

### 5-3: Technical Effectiveness of Information Processing Apparatus 5

The information processing apparatus 5 according to the fifth example embodiment can perform the iris authentication even when the iris area Ir and the pattern area Pa are similar to each other and the boundary between the iris area Ir and the pattern area Pa is unclear. The information processing apparatus 5 can determine the inner boundary of the pattern area Pa by utilizing the fact that the iris area Ir and the pattern area Pa differ from each other in their three-dimensional shapes. Then, the information processing apparatus 5 can appropriately perform the iris authentication. Prior to the image matching among the eye images, the information processing apparatus 5 adjusts the rotational angle around the pupil as the center among the eye images by using the pattern of the iris area Ir of the iris authentication target person, the iris area Ir being close to the pupil area Pu of the iris authentication target person in the eye image. Thereby, the information processing apparatus 5 can perform the image matching among the eye images with high accuracy. The information processing apparatus 5 performs the image matching between the first eye image and the second eye image, extracts the common area common to the first and second eye images, calculates the distance from the center of the pupil area Pu to the outer boundary of the common area, calculates the inner radius of the pattern area Pa based on the longest one of the distances calculated, and determines the inner boundary based on the inner radius. Thereby, the information processing apparatus 5 can perform the iris authentication with a larger iris area Ir.

Further, the plurality of eye images to be used by the information processing apparatus 5, include at least one of: a plurality of eye images captured by making the iris authentication target person change the direction of the line of sight: a plurality of eye images captured by making the iris authentication target person change the direction of the face with fixing the direction of the line of sight of the iris authentication target person: a plurality of eye images captured by making the imaging apparatus for imaging the eye image move: and a plurality of eye images captured by the plurality of imaging apparatuses. Thereby, the information processing apparatus 5 can acquire the plurality of eye images in a manner suitable for the situation.

### 6: Sixth Example Embodiment

A sixth example embodiment of an information processing apparatus, information processing method, and recording medium will be described. Hereinafter, there will be described the sixth example embodiment of the information processing apparatus, information processing method, and recording medium, using an information processing apparatus 6 to which the sixth example embodiment of the information processing apparatus, information processing method, and recording medium is applied.

The information processing apparatus 6 according to the sixth example embodiment comprises the arithmetic apparatus 21 and the storage apparatus 22, similarly to at least one of the information processing apparatus 4 according to the fourth example embodiment and the information processing apparatus 5 according to the fifth example embodiment. Furthermore, the information processing apparatus 6 may comprise the communication apparatus 23, the input apparatus 24, and the output apparatus 25, similarly to at least one of the information processing apparatus 4 and the information processing apparatus 5. However, the information processing apparatus 6 may not comprise at least one of the communication apparatus 23, the input apparatus 24, and the output apparatus 25. The information processing apparatus 6 according to the sixth example embodiment differs from at least one of the information processing apparatus 4 according to the fourth example embodiment and the information processing apparatus 5 according to the fifth example embodiment in the determination operation performed by the determination portion 211. The other features of the information processing apparatus 6 may be the same as those of at least one of the information processing apparatus 4 and the information processing apparatus 5.

### 6-1: Information Processing Operation Performed by Information Processing Apparatus 6

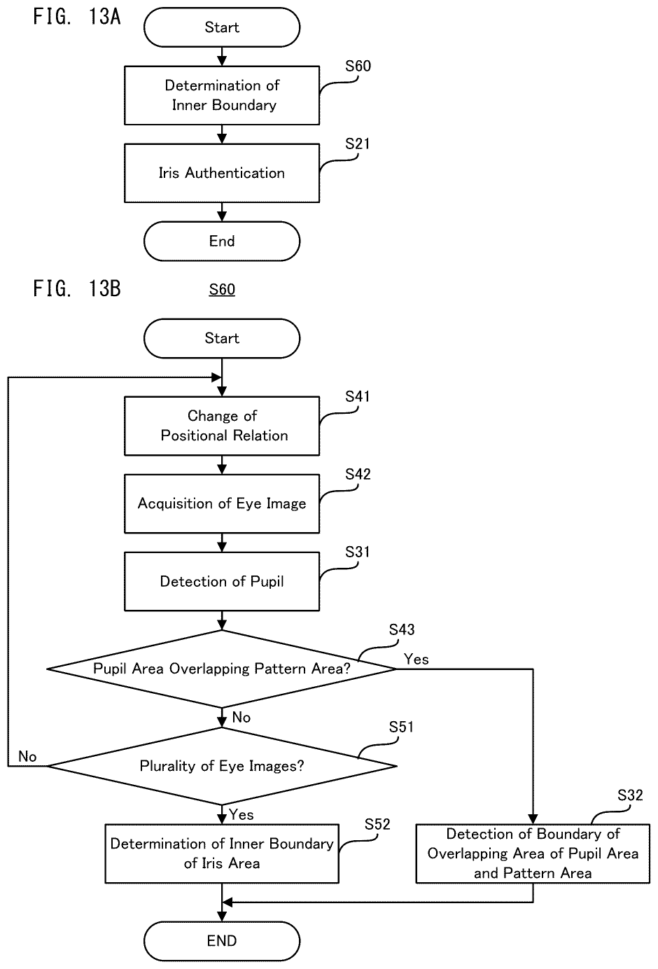

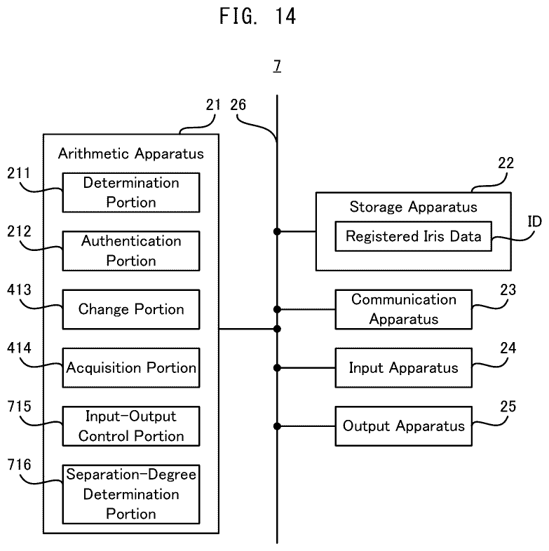

Referring to FIG. 13, a flow of the information processing operation performed by the information processing apparatus 6 according to the sixth example embodiment will be described. FIG. 13 includes flow charts showing the flow of the information processing operation performed by the information processing apparatus 6 according to the sixth example embodiment.

As shown in FIG. 13(a), the determination portion 211 determines the inner boundary of the pattern area Pa included in the eye image from the eye image including the eye of the iris authentication target person (step S60). The iris authentication portion 212 performs the iris authentication for the iris authentication target person based on the inner boundary of the pattern area Pa (step S21).

The operation on step S60 is shown in FIG. 13(b). As shown in FIG. 13(b), the change portion 413 changes the positional relation between the direction of the line of sight of the iris authentication target person and the imaging direction of the imaging apparatus for imaging the iris authentication target person (step S41). The acquisition portion 414 acquires the eye image generated by the imaging apparatus (step S42). The determination portion 211 detects the pupil area Pu of the iris authentication target person included in the eye image (step S31). The change portion 413 determines whether the pupil area Pu of the iris authentication target person included in the eye image and the pattern area Pa in the eye image are overlapping with each other (step S43).

When the pupil area Pu of the iris authentication target person and the pattern area Pa are overlapping with each other (step S43: Yes), the determination portion 211 determines the inner boundary of the pattern area Pa using the overlapping area where the pupil area Pu of the iris authentication target person included in the eye image and the pattern area Pa in the eye image are overlapping with each other (step S32).

If the pupil area Pu of the iris authentication target person and the pattern area Pa do not overlap (step S43: No), the determination portion 211 determines whether the acquisition portion 414 has acquired the plurality of eye images at least including the first eye image where the line of sight of the iris authentication target person is directed in the first direction, and the second eye image where the line of sight of the iris authentication target person is directed in the second direction differing from the first direction (step S51).

If the iris acquisition portion 414 has not yet acquired the plurality of eye images at least including the first eye image where the line of sight of the iris authentication target person is directed in the first direction and the second eye image where the line of sight of the iris authentication target person is directed in the second direction different from the first direction (step S51: No), the operation proceeds to step S41.

If the acquisition portion 414 has acquired the plurality of eye images at least including the first eye image where the line of sight of the iris authentication target person is directed in the first direction and the second eye image where the line of sight of the iris authentication target person is directed in the second direction different from the first direction (step S51: Yes), the determination portion 211 performs the determination operation of the inner boundary of the pattern area Pa (step S52).

In step S21 in the sixth example embodiment, when the pupil area Pu of the iris authentication target person and the pattern area Pa are overlapping with each other (step S43: Yes), similarly to step S21 in the third example embodiment, the iris authentication portion 212 may extract the iris feature by masking the pattern area Pa in the eye image. As shown in FIG. 6(e), the pattern area Pa may be masked by the pattern area M surrounded by the outer boundary OB and the inner boundary IB. The iris authentication portion 212 may verify the iris image where the pattern area included in the patterned contact lens is not overlapping, with the registered iris data ID, to perform the iris authentication. The iris authentication portion 212 may verify with the feature included in the registered iris data ID, the feature extracted from the iris image where the pattern area included in the patterned contact lens is not overlapping, to perform the iris authentication.

When the pupil area of the iris authentication target person and the pattern area is not overlapping with each other (step S43: No), similarly to step S21 in the fifth example embodiment, the iris authentication portion 212 may extract the iris feature from the iris area Ir on the inner side of the inner boundary of the pattern area Pa having the distance dl from the center PaC of the patterned contact lens in the eye image. As shown in FIG. 11(f), the pattern area Pa may be masked with the area surrounded by the outer boundary OB and inner boundary IB of the pattern area Pa. The iris authentication portion 212 may verify with the registered iris data ID, the iris image where the pattern area included in the patterned contact lens is overlapping, to perform the iris authentication. The iris authentication portion 212 may verify with the feature included in the registered iris data ID, the feature extracted from the iris image where the pattern area included in the patterned contact lens is not overlapping, to perform the iris authentication. Further, as described in the second example embodiment, the iris authentication portion 212 may perform the feature extraction using an image with no masking, and the masking processing may be performed after the feature extraction or after the matching processing.

In the above-described example embodiments each, the boundary between the pupil area Pu and the pattern area Pa is set to a reference for computing the inner radius of the pattern area Pa. However, this is not limitation. For example, when the eyeball is moved widely, the outer side of the iris area could go in the inner side of the pattern area Pa. In this case, the boundary between the white-eye (that is, sclera) area and the pattern area Pa may be set to the criterion of the inner radius of the pattern area Pa.

### 6-2: Technical Effectiveness of Information Processing Apparatus 6

In many cases, the pattern area Pa can be detected more accurately by the method of determining the inner boundary of the pattern area Pa using the overlapping area where the pupil area Pu of the iris authentication target person included in the eye image and the pattern area Pa in the eye image are overlapping with each other. Therefore, the information processing apparatus 6 according to the sixth example embodiment basically uses a method of determining the inner boundary of the pattern area Pa using the overlapping area where the pupil area Pu of the iris authentication target person included in the eye image and the pattern area Pa in the eye image are overlapping with each other. As an alternative to the case where the pupil area Pu and the pattern area Pa are not overlapping with each other, the information processing apparatus 6 employs a method of determining the inner boundary using the plurality of eye images, thereby improving the iris-authentication accuracy.

### 7: Seventh Example Embodiment

A seventh example embodiment of an information processing apparatus, information processing method, and recording medium will be described. Hereinafter, there will be described the seventh example embodiment of the information processing apparatus, information processing method, and recording medium, using an information processing apparatus 7 to which the seventh example embodiment of the information processing apparatus, information processing method, and recording medium is applied.

### 7-1: Configuration of Information Processing Apparatus 7

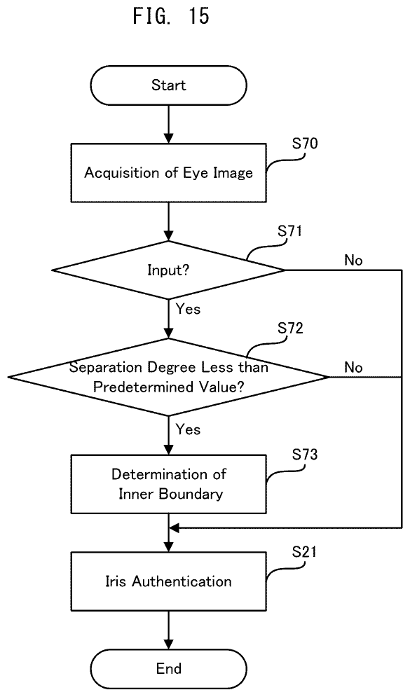

Referring to FIG. 14, the configuration of the information processing apparatus 7 according to the seventh example embodiment will be described. FIG. 14 is a block diagram illustrating the configuration of the information processing apparatus 7 according to the seventh example embodiment.

As illustrated in FIG. 14, the information processing apparatus 7 according to the seventh example embodiment comprises the arithmetic apparatus 21 and the storage apparatus 22, similarly to at least one of the information processing apparatuses 4 to 6 according to the fourth to sixth example embodiments respectively. Furthermore, the information processing apparatus 7 may comprise the communication apparatus 23, the input apparatus 24, and the output apparatus 25, similarly to at least one of the information processing apparatuses 4 to 6. However, the information processing apparatus 7 may not comprise at least one of the communication apparatus 23, the input apparatus 24, and the output apparatus 25. The information processing apparatus 7 according to the seventh example embodiment differs from at least one of the information processing apparatuses 4 to 6 according to the fourth to sixth example embodiments respectively, in that the arithmetic apparatus 21 comprises an input-output control portion 715 and a separation-degree determination portion 716. Also, the input apparatus 24 accepts an input of patterned-contact wearing data indicating that the iris authentication target person is wearing the patterned contact lens. The input apparatus 24 may include an operational apparatus (e.g., at least one of a keyboard, a mouse, and a touch panel) operable by the iris authentication target person. In addition, the output apparatus 25 may be output to prompt the iris authentication target person to input the patterned-contact wearing data. The output apparatus 25 may include at least one of: a display apparatus (so-called a display) capable of displaying an image indicating information for prompting input of the patterned contact wearing information: and an audio apparatus (so-called speaker) capable of outputting audio for prompting the same. The other features of the information processing apparatus 7 may be the same as those of at least one of the information processing apparatuses 4 to 6. Details of the input-output control portion 715 and the separation-degree determination portion 716 will be described later.

### 7-2: Information Processing Operation Performed by Information Processing Apparatus 7

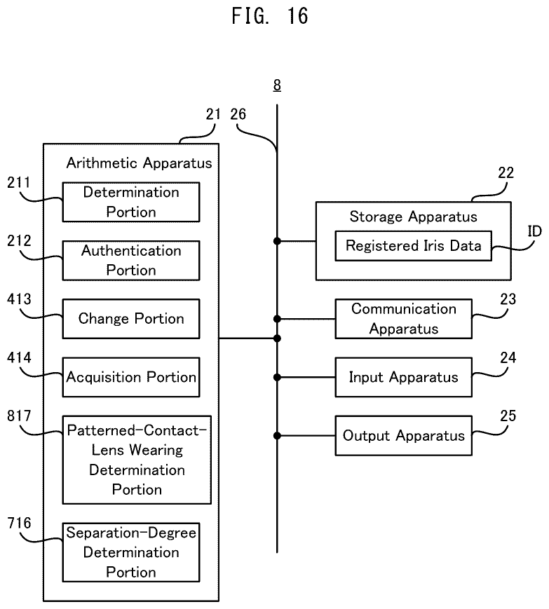

Referring to FIG. 15, a flow of the information processing operation performed by the information processing apparatus 7 according to the seventh example embodiment will be described. FIG. 15 is a flow chart showing the flow of the information processing operation performed by the information processing apparatus 7 according to the seventh example embodiment.

As shown in FIG. 15, the acquisition portion 414 acquires the eye image of the iris authentication target person (step S70).

The input-output control portion 715 determines whether or not input information indicating that the iris authentication target person is wearing the patterned contact lens is input to the input apparatus 24 (step S71). When the input information is input (step S71: Yes), the separation-degree determination portion 716 determines whether or not the separation degree between the pattern of the pattern area Pa included in the patterned contact lens and the pattern of the iris area Ir of the iris authentication target person is less than a predetermined value (step S72). The separation-degree determination portion 716 may determine whether or not the separation degree (distinguishability) between the pattern of the pattern area Pa included in the patterned contact lens and the pattern of the iris area Ir of the iris authentication target person is less than the predetermined value, using the pattern of an adjacent portion to the white portion of the eyeball as the pattern of the pattern area Pa and the pattern of an adjacent portion to the pupil area Pu as the pattern of the iris area Ir of the iris authentication target person. As a method of calculating the separation degree, it is possible to use various existing techniques based on the statistic of the pixel value and its frequency components, or the like.

When the separation degree between the pattern of the pattern area Pa and the pattern of the iris area Ir of the iris authentication target person is less than the predetermined value (step S72: Yes), the determination portion 211 determines the inner boundary (step S73). The determination operation of the inner boundary on step S73 in the seventh example embodiment may be the same as at least one of: the determination operation of the inner boundary on step S20 in the second example embodiment: the determination operation of the inner boundary on step S30 in the third example embodiment: the determination operation of the inner boundary on step S40 in the fourth example embodiment: the determination operation of the inner boundary on step S50 in the fifth example embodiment: and the determination operation of the inner boundary on step S60 in the sixth example embodiment.

The Iris authentication portion 212 performs the iris authentication (step S21). If the determination portion 211 determines the inner boundary on step S73, the iris authentication portion 212 performs the iris authentication for the iris authentication target person based on the inner boundary.

On the other hand, if the input information is not input (step S71: No) and the separation degree between the pattern of the pattern area Pa and the pattern of the iris area Ir of the iris authentication target person is equal to or more than the predetermined value (step S72: No), the iris authentication portion 212 may perform the iris authentication using all of the iris area Ir included in the eye image (step S21).

That is, the change portion 413 changes the positional relation, when the input information indicating that the iris authentication target person is wearing the patterned contact lens is input to the information processing apparatus 7 and also the separation degree between the pattern of the pattern area Pa included in the patterned contact lens and the pattern of the iris area Ir of the iris authentication target person is less than the predetermined value. On the other hand, the change portion 413 does not change the positional relation, when the input information is not input to the information processing apparatus 7, or when the input information is input to the information processing apparatus 7 and also the separation degree is equal to or more than the predetermined value.

In the seventh example embodiment, when the iris authentication target person is not wearing the patterned contact lens, the iris authentication using all of the iris area included in the eye image may be performed as usual. In addition, if the pattern of the iris area Ir can be distinguished from the pattern of the pattern area Pa, the iris authentication using the eye image where the iris is captured from the front may be performed. Then, if the pattern of the iris area Ir and the pattern of the pattern area Pa cannot be distinguished from each other, the determination operation of the inner boundary disclosed in any of the second to sixth example embodiments may be performed.

### 7-3: Technical Effectiveness of Information Processing Apparatus 7

With respect to the iris authentication, using a larger iris area Ir can improve the accuracy of the iris authentication. The information processing apparatus 7 according to the seventh example embodiment, when the iris authentication target person is not wearing the patterned contact lens, the iris authentication is performed using all of the iris area Ir included in the eye image as usual. Thereby, the accuracy of the iris authentication is good. In addition, when the pattern of the iris and the pattern of the patterned contact lens pattern can be distinguished from each other, the information processing apparatus 7 may perform the iris authentication using an image where the iris is captured from the front. In other words, since the information processing apparatus 7 does not prompt the iris authentication target person to move the line of sight or the like, the convenience to the iris authentication target person is good. When the pattern of the iris and the pattern of the patterned contact lens cannot be distinguished from each other, the information processing apparatus 7 performs the determination operation of the inner boundary in any of the second to sixth example embodiments. Thereby, it is possible to improve the success rate of the iris authentication for the iris authentication target person.

### 8: Eighth Example Embodiment

An eighth example embodiment of an information processing apparatus, information processing method, and recording medium will be described. Hereinafter, there will be described the eighth example embodiment of the information processing apparatus, information processing method, and recording medium, using an information processing apparatus 8 to which the eighth example embodiment of the information processing apparatus, information processing method, and recording medium is applied.

### 8-1: Configuration of Information Processing Apparatus 8

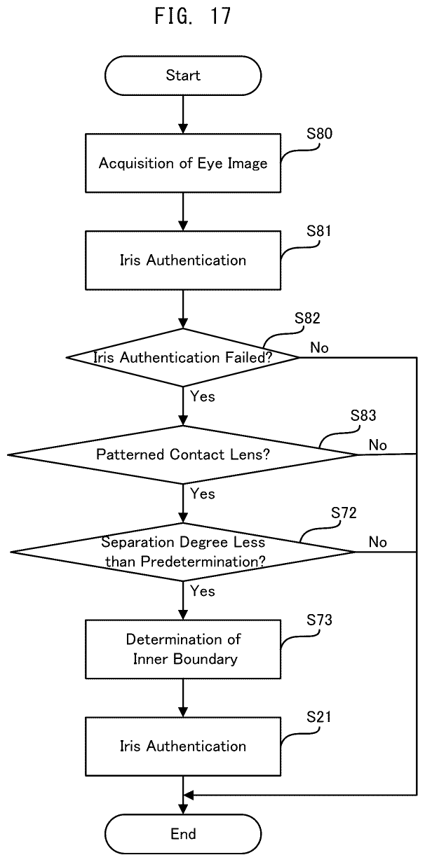

Referring to FIG. 16, the configuration of the information processing apparatus 8 according to the eighth example embodiment will be described. FIG. 16 is a block diagram illustrating the configuration of the information processing apparatus 8 according to the eighth example embodiment.

As illustrated in FIG. 16, the information processing apparatus 8 according to the eighth example embodiment comprises the arithmetic apparatus 21 and the storage apparatus 22, similarly to at least one of the information processing apparatuses 4 to 6 according to the fourth to sixth example embodiments respectively. Furthermore, the information processing apparatus 7 may comprise the communication apparatus 23, the input apparatus 24, and the output apparatus 25, similarly to at least one of the information processing apparatuses 4 to 6. However, the information processing apparatus 7 may not comprise at least one of the communication apparatus 23, the input apparatus 24, and the output apparatus 25. The information processing apparatus 8 according to the eighth example embodiment differs from at least one of the information processing apparatuses 4 to 6 according to the fourth to sixth example embodiments respectively, in that the arithmetic apparatus 21 comprises a patterned-contact-lens wearing determination portion 817 and the separation-degree determination portion 716. The other features of the information processing apparatus 8 may be the same as those of at least one of the information processing apparatuses 4 to 6. Details of the patterned-contact-lens wearing determination portion 817 and the separation-degree determination portion 716 will be described later.

### 8-2: Information Processing Operation Performed by Information Processing Apparatus 8

Referring to FIG. 17, a flow of the information processing operation performed by the information processing apparatus 8 according to the eighth example embodiment will be described. FIG. 17 is a flow chart showing the flow of the information processing operation performed by the information processing apparatus 8 according to the eighth example embodiment.

As shown in FIG. 17, the acquisition portion 414 acquires the eye image of the iris authentication target person (step S80). The iris authentication portion 212 performs the iris authentication using all iris area included in the eye image (step S81).

The iris authentication portion 212 determines whether or not the iris authentication in step S81 has failed (step S82). If the iris authentication has failed (step S82: Yes), the patterned-contact-lens wearing determination portion 817 determines whether or not the iris authentication target person wears the patterned contact lens (step S83). The patterned-contact-lens wearing determination portion 817 may determine that the iris authentication target person is wearing the patterned contact lens, for example, when there is a difference between the movement of a portion adjacent to the white portion of the eyeball and the movement of the pupil area Pu. The white portion of the eyeball may be, so-called the white eye portion, a sclera that is a white covering of the outside of the eyeball.

When the iris authentication target person is wearing the patterned contact lens (step S83: Yes), the separation-degree determination portion 716 determines whether or not the separation degree between the pattern of the pattern area Pa included in the patterned contact lens and the pattern of the iris area Ir of the iris authentication target person is less than a predetermined value (step S72). The method for determination is similar to the method on step S72 in the seventh example embodiment.

When the separation degree between the pattern of the pattern area Pa and the pattern of the iris area Ir of the iris authentication target person is less than the predetermined value (step S72: Yes), the determination portion 211 determines the inner boundary (step S73). The determination operation of the inner boundary on step S73 in the eighth example embodiment may be the same as any one of: the determination operation of the inner boundary on step S20 in the second example embodiment: the determination operation of the inner boundary on step S30 in the third example embodiment: the determination operation of the inner boundary on step S40 in the fourth example embodiment: the determination operation of the inner boundary on step S50 in the fifth example embodiment: and the determination operation of the inner boundary on step S60 in the sixth example embodiment.

The iris authentication portion 212 performs the iris authentication (step S21). When the determination portion 211 has determined the inner boundary on step S73, the iris authentication for the iris authentication target person is performed based on the inner boundary.

Meanwhile, when the iris authentication on step S81 has not failed (step S82: No), when the iris authentication target person is not wearing the patterned contact lens (step S83: No), or when the separation degree between the pattern of the pattern area Pa and the pattern of the iris area Ir of the iris authentication target person is equal to or more than the predetermined value (step S72: No), the information processing operation ends.

That is, the change portion 413 changes the positional relation, when the iris authentication of the iris authentication target person has failed, when the iris authentication target person is wearing the patterned contact lens, and/or when the separation degree between the pattern of the pattern area Pa included in the patterned contact lens and the pattern of the iris area Ir of the iris authentication target person is less than the predetermined value.

In the eighth example embodiment, when the iris authentication using all of the iris area included in the normal eye image has failed, the determination operation of the inner boundary in any one of the second to sixth example embodiments is performed so as to improve the success rate of the iris authentication for the iris authentication target person.

When the iris authentication has failed (step S82: Yes), the determination on step S71 in the seventh example embodiment, instead of the determination on step S83, may be performed so that the iris authentication target person can make self-declaration that he/she is wearing the patterned contact lens.

Also, at least one of: step S82: step S83: and step S72 may not be performed.

### 8-3: Technical Effectiveness of Information Processing Apparatus 8

With respect to the iris authentication, it is possible to improve its accuracy to use a larger iris area Ir. In the eighth example embodiment, the information processing apparatus 8 performs the iris authentication using all of the iris area included in the usual eye image. Therefore, the accuracy of the iris authentication is good. The information processing apparatus 8 performs the determination operation of the inner boundary in any one of the second to sixth example embodiments even when the iris authentication has failed due to the fact that the iris authentication target person is wearing the patterned contact lens where it is hard to distinguish between the pattern of the pattern area Pa and the pattern of the iris area Ir. Thereby, it is possible to reduce the risk that the iris authentication is unavailable when the iris authentication target person is wearing the patterned contact lens, and to improve the usability by improving the success rate of the iris authentication for the iris authentication target person.

### 9: Supplementary Note

With respect to the example embodiments described above, the following supplementary notes are further disclosed.

### Supplementary Note 1

An information processing apparatus comprising: a determination unit that determines, in a case where an iris authentication target person is wearing a patterned contact lens including a predetermined pattern area, from an eye image including an eye of the iris authentication target person, an inner boundary of the pattern area included in the eye image: and an iris authentication unit that performs iris authentication for the iris authentication target person based on the inner boundary.

### Supplementary Note 2

The information processing apparatus according to the supplementary note 1, wherein the iris authentication unit, to perform the iris authentication for the iris authentication target person, extracts the pattern area included in the patterned contact lens based on the inner boundary, and performs either one of: masking the pattern area in the eye image: masking a feature corresponding to the pattern area within an iris feature extracted from the eye image: and masking a result corresponding to the pattern area within a result of matching performed with using the iris feature extracted from the eye image.

### Supplementary Note 3

The information processing apparatus according to the supplementary note 1 or 2, wherein, the determination unit determines, in a case where a pupil area of the iris authentication target person included in the eye image and the pattern area in the eye image are overlapping with each other, the inner boundary using the overlapping area.

### Supplementary Note 4

The information processing apparatus according to the supplementary note 3, wherein the determination unit calculates, in a case where the pupil area and the pattern area are overlapping with each other, an inner radius of the pattern area based on a distance from a center of the patterned contact lens to an inner side of the overlapping area, and determines the inner boundary based on the inner radius.

### Supplementary Note 5

The information processing apparatus according to the supplementary note 3 or 4, further comprising a change unit that changes a positional relation between a direction of a line of sight of the iris authentication target person and an imaging direction of an imaging apparatus for imaging the iris authentication target person.

### Supplementary Note 6

The information processing apparatus according to the supplementary note 5, wherein the change unit changes the positional relation in a case where the pupil area of the iris authentication target person included in the eye image and the pattern area in the eye image are not overlapping with each other, and also in a case where the pupil area of the iris authentication target person included in the eye image is equal to or larger than a predetermined size.

### Supplementary Note 7

The information processing apparatus according to the supplementary note 5 or 6, wherein the change unit changes the positional relation by performing at least one of: a first operation for prompting the iris authentication target person to change a direction of the line of sight: a second operation for prompting the iris authentication target person to change a direction of his/her face while a direction of the line of sight is fixed: and a third operation for moving the imaging apparatus for imaging the iris authentication target person with respect to the iris authentication target person.

### Supplementary Note 8

The information processing apparatus according to any one of the supplementary notes 5 to 7, wherein the change unit changes the positional relation, in a case where input information indicating that the iris authentication target person is wearing the patterned contact lens is input into the information processing apparatus, and also in a case where a separation degree between a pattern of the pattern area included in the patterned contact lens and a pattern of an iris area of the iris authentication target person is less than a predetermined value, and the change unit does not change the positional relation, in a case where the input information is not input into the information processing apparatus, or in a case where the input information is input into the information processing apparatus and also the separation degree is equal to or more than the predetermined value.

### Supplementary Note 9

The information processing apparatus according to any one of the supplementary notes 5 to 8, wherein the change unit changes the positional relation, in a case where the iris authentication for the iris authentication target person has failed, in a case where the iris authentication target person is wearing the patterned contact lens, and/or in a case where a separation degree between a pattern of the pattern area included in the patterned contact lens and a pattern of an iris area of the iris authentication target person is less than a predetermined value.

### Supplementary Note 10

The information processing apparatus according to any one of the supplementary notes 1 to 9, wherein the determination unit performs matching among a plurality of eye images at least including a first eye image where a line of sight of the iris authentication target person is directed in a first direction and a second eye image where the line of sight of the iris authentication target person is directed in a second direction different from the first direction, and determines the inner boundary.

### Supplementary Note 11

The information processing apparatus according to any one of the supplementary notes 1 to 9, wherein the determination unit, in a case where a pupil area of the iris authentication target person included in the eye image and the pattern area in the eye image are not overlapping with each other, performs matching among a plurality of eye images at least including a first eye image where a line of sight of the iris authentication target person is directed in a first direction and a second eye image where the line of sight of the iris authentication target person is directed in a second direction different from the first direction, and determines the inner boundary.

### Supplementary Note 12

The information processing apparatus according to the supplementary note 10 or 11, wherein the determination unit, before the matching among the plurality of eye images, adjusts a rotational angle around a pupil as a center among the plurality of eye images, by using a pattern of an iris area of the iris authentication target person close to a pupil area of the iris authentication target person included in the eye image.

### Supplementary Note 13

The information processing apparatus according to any one of the supplementary notes 10 to 12, wherein the determination unit performs the matching between the first eye image and the second eye image, extracts a common area common to the first and second eye images, calculates a distance from a center of a pupil area of the iris authentication target person to an outer boundary of the common area, calculates an inner radius of the pattern area based on a longest one of the distances calculated, and determines the inner boundary based on the inner radius.

### Supplementary Note 14

The information processing apparatus according to any one of the supplementary notes 10 to 13, wherein the plurality of eye images include at least one of: a plurality of eye images captured by making the iris authentication target person change a direction of his/her line of sight: a plurality of eye images captured by making the iris authentication target person change a direction of his/her face with fixing a direction of the line of sight of the iris authentication target person: a plurality of eye images captured by making an imaging apparatus for imaging the eye image move: and a plurality of eye images captured by a plurality of imaging apparatuses.

### Supplementary Note 15

An information processing method comprising: determining, in a case where an iris authentication target person is wearing a patterned contact lens including a predetermined pattern area, from an eye image including an eye of the iris authentication target person, an inner boundary of the pattern area included in the eye image: and performing iris authentication for the iris authentication target person based on the inner boundary.

### Supplementary Note 16

A recording medium on which a computer program that allows at least one computer to execute an information processing method is recorded, the information processing method comprising: determining, in a case where an iris authentication target person is wearing a patterned contact lens including a predetermined pattern area, from an eye image including an eye of the iris authentication target person, an inner boundary of the pattern area included in the eye image: and performing iris authentication for the iris authentication target person based on the inner boundary.

At least a part of the constituent components of the above-described example embodiments can be appropriately combined with at least the other part of the constituent components of the above-described example embodiments. A part among the constituent components of the above-described example embodiments may not be used. Also, to the extent permitted by law, the disclosure of all references (e.g., the patent documents) cited in the above-mentioned disclosure is incorporated as a part of the description of this disclosure.

This disclosure may be appropriately modified in a range which is not contrary to the technical idea which can be read throughout the claims and whole specification. The information processing apparatus, information processing method, and recording medium with such modifications are also included in the technical idea of this disclosure.

### DESCRIPTION OF REFERENCE CODES

1,2,3,4,5,6,7,8 Information Processing Apparatus
11,211 Determination Portion
12,212 Iris Authentication Portion
413 Change Portion
414 Acquisition Portion
715 Input-output Control Portion
716 Separation-Degree Determination Portion
817 Patterned-Contact-Lens Wearing Determination Portion
Pu Pupil Area
Ir Iris Area
Pa Pattern Area

What is claimed is:

1. An information processing apparatus comprising:
at least one memory configured to store instructions; and
at least one processor configured to execute the instructions to:
determine, in a case where an iris authentication target person is wearing a patterned contact lens including a predetermined pattern area, from an eye image including an eye of the iris authentication target person, an inner boundary of the pattern area included in the eye image; and
perform iris authentication for the iris authentication target person based on the inner boundary.

2. The information processing apparatus according to claim 1, wherein
the at least one processor is further configured to execute the instructions to
for performing the iris authentication for the iris authentication target person, extract the pattern area included in the patterned contact lens based on the inner boundary, and perform either one of: masking the pattern area in the eye image; masking a feature corresponding to the pattern area within an iris feature extracted from the eye image; and masking a result corresponding to the pattern area within a result of matching performed with using the iris feature extracted from the eye image.

3. The information processing apparatus according to claim 1, wherein,
the at least one processor is further configured to execute the instructions to
determine, in a case where a pupil area of the iris authentication target person included in the eye image and the pattern area in the eye image are overlapping with each other, the inner boundary using the overlapping area.

4. The information processing apparatus according to claim 3, wherein
the at least one processor is further configured to execute the instructions to
calculate, in a case where the pupil area and the pattern area are overlapping with each other, an inner radius of the pattern area based on a distance from a center of the patterned contact lens to an inner side of the overlapping area, and determine the inner boundary based on the inner radius.

5. The information processing apparatus according to claim 3 wherein
the at least one processor is further configured to execute the instructions to
change a positional relation between a direction of a line of sight of the iris authentication target person and an imaging direction of an imaging apparatus for imaging the iris authentication target person.

6. The information processing apparatus according to claim 5, wherein
the at least one processor is further configured to execute the instructions to
change the positional relation in a case where the pupil area of the iris authentication target person included in the eye image and the pattern area in the eye image are not overlapping with each other, and also in a case where the pupil area of the iris authentication target person included in the eye image is equal to or larger than a predetermined size.

7. The information processing apparatus according to claim 5, wherein
the at least one processor is further configured to execute the instructions to
change the positional relation by performing at least one of: a first operation for prompting the iris authentication target person to change a direction of the line of sight; a second operation for prompting the iris authentication target person to change a direction of his/her face while a direction of the line of sight is fixed; and a third operation for moving the imaging apparatus for imaging the iris authentication target person with respect to the iris authentication target person.

8. The information processing apparatus according to claim 5, wherein
the at least one processor is further configured to execute the instructions to
change the positional relation, in a case where input information indicating that the iris authentication target person is wearing the patterned contact lens is input into the information processing apparatus, and also in a case where a separation degree between a pattern of the pattern area included in the patterned contact lens and a pattern of an iris area of the iris authentication target person is less than a predetermined value, and
not to change the positional relation, in a case where the input information is not input into the information processing apparatus, or in a case where the input information is input into the information processing apparatus and also the separation degree is equal to or more than the predetermined value.

9. The information processing apparatus according to claim 5, wherein
the at least one processor is further configured to execute the instructions to
change the positional relation, in a case where the iris authentication for the iris authentication target person has failed, in a case where the iris authentication target person is wearing the patterned contact lens, and/or in a case where a separation degree between a pattern of the pattern area included in the patterned contact lens and a pattern of an iris area of the iris authentication target person is less than a predetermined value.

10. The information processing apparatus according to claim 1, wherein
the at least one processor is further configured to execute the instructions to
perform matching among a plurality of eye images at least including a first eye image where a line of sight of the iris authentication target person is directed in a first direction and a second eye image where the line of sight of the iris authentication target person is directed in a second direction different from the first direction, and determine the inner boundary.

11. The information processing apparatus according to any one of claim 1, wherein
the at least one processor is further configured to execute the instructions to
in a case where a pupil area of the iris authentication target person included in the eye image and the pattern area in the eye image are not overlapping with each other, perform matching among a plurality of eye images at least including a first eye image where a line of sight of the iris authentication target person is directed in a first direction and a second eye image where the line of sight of the iris authentication target person is directed in a second direction different from the first direction, and determine the inner boundary.

12. The information processing apparatus according to claim , wherein
the at least one processor is further configured to execute the instructions to before the matching among the plurality of eye images, adjust a rotational angle around a pupil as a center among the plurality of eye images, by using a pattern of an iris area of the iris authentication target person close to a pupil area of the iris authentication target person included in the eye image.

13. The information processing apparatus according to claim 10, wherein
the at least one processor is further configured to execute the instructions to
perform the matching between the first eye image and the second eye image, extract a common area common to the first and second eye images, calculate a distance from a center of a pupil area of the iris authentication target person to an outer boundary of the common area, calculate an inner radius of the pattern area based on a longest one of the distances calculated, and determine the inner boundary based on the inner radius.

14. The information processing apparatus according to claim 10, wherein
the plurality of eye images include at least one of: a plurality of eye images captured by making the iris authentication target person change a direction of his/her line of sight; a plurality of eye images captured by making the iris authentication target person change a direction of his/her face with fixing a direction of the line of sight of the iris authentication target person; a plurality of eye images captured by making an imaging apparatus for imaging the eye image move; and a plurality of eye images captured by a plurality of imaging apparatuses.

15. An information processing method comprising:
determining, in a case where an iris authentication target person is wearing a patterned contact lens including a predetermined pattern area, from an eye image including an eye of the iris authentication target person, an inner boundary of the pattern area included in the eye image; and
performing iris authentication for the iris authentication target person based on the inner boundary.

16. A non-transitory recording medium on which a computer program that allows at least one computer to execute an information processing method is recorded,
the information processing method comprising:
determining, in a case where when an iris authentication target person is wearing a patterned contact lens including a predetermined pattern area, from an eye image including an eye of the iris authentication target person, an inner boundary of the pattern area included in the eye image; and
performing iris authentication for the iris authentication target person based on the inner boundary.
